(19) United States
(12) Patent Application Publication
(10) Pub. No.: US 2008/0159533 A1
(43) Pub. Date: Jul. 3, 2008

(54) System and method of processing data

(75) Inventors: Norman L. Schryer, New Providence, NJ (US); Thomas Killian, Westfield, NJ (US); Constance Coty, White House, NJ (US)

Correspondence Address: TOLER LAW GROUP, 8500 BLUFFSTONE COVE, SUITE A201, AUSTIN, TX, 78759, US

(73) Assignee: AT&T Knowledge Ventures, LP, Reno, NV (US)

(21) Appl. No.: 11/647,510

(22) Filed: Dec. 28, 2006

(51) Int. Cl. H04N 7/167

(52) U.S. Cl. 380/231; 380/237

(57) ABSTRACT

A system and method of processing data are provided. The method may include encoding a first watermark into a data file to form first watermarked data. The data file may include audio data. The method may also include sending the first watermarked data to a remotely located user device associated with a user. The method may also include receiving a request from the user to resend the audio data. The method may further include encoding a second watermark into the data file to form second watermarked data. The method may also include sending the second watermarked data to the user device.

### FIELD OF THE DISCLOSURE

The present disclosure is generally related to processing of data.

### BACKGROUND

In general, the increasing popularity of portable media players, such as ‘MP3 players’ has led to increasing demand for media content that can be played on such players. Some sources of media content are available via data networks, such as the Internet. However, there is a perception that some of the media content accessible via such data networks is illegal, e.g., in violation of U.S. or foreign copyright laws. As a result, some people may be concerned that certain data files they possess may be illegal or that they may be accused of possessing illegal copies of media content.

Additionally, while general uses of media players may be relatively simple and convenient, preparing them for certain uses may be difficult or cumbersome. For example, some people may not be familiar enough with the available technology or may not have access to technology to convert media content between formats utilized by the media players. Hence, there is a need for improved system and method of processing audio data.

### BRIEF DESCRIPTION OF THE DRAWINGS

FIG. 1 depicts a block diagram of a particular embodiment of a system for processing data;

FIG. 2 depicts a flow chart of a first particular embodiment of a method of processing data;

FIG. 3 depicts a flow chart of a second particular embodiment of a method of processing data;

FIG. 4 depicts a flow chart of a third particular embodiment of a method of processing data; and

FIG. 5 depicts an illustrative embodiment of a general computer system.

### DETAILED DESCRIPTION OF THE DRAWINGS

In a first particular embodiment, a system for processing data may include a watermarking module to embed a first watermark within audio data to form first watermarked data. The system may also include a transmission module to send the first watermarked data to a user device. In an illustrative embodiment, in response to receiving a request to resend the audio data, the watermarking module may embed a second watermark within the audio data to form second watermarked data. The transmission module may send the second watermarked data to the user device.

In a second particular embodiment, a system for processing data may include a watermarking module to embed a computer detectible watermark within audio data to form watermarked data. The system may also include a memory to store a record associating the computer detectible watermark with a user. The system may further include a transmission module to send the watermarked data to a user device. The system may also include logic in communication with the memory. In a particular embodiment, in response to receiving a request to resend the audio data, the logic may identify the watermark associated with the user and the transmission module may resend the watermarked data to the user device.

In a first particular embodiment, a method of processing data may include encoding a first watermark into a data file to form first watermarked data. The data file may include audio data. The method may also include sending the first watermarked data to a remotely located user device associated with a user. The method may also include receiving a request from the user to resend the audio data. The method may further include encoding a second watermark into the data file to form second watermarked data. The method may also include sending the second watermarked data to the user device.

In a second particular embodiment, a method of processing data may include encoding a first watermark into a first data file to form first watermarked data. The first data file may include first audio data. The method may further include storing a first record associating the first watermark with a first user. The method may also include sending the first watermarked data to a remotely located first user device associated with the first user. The method may further include receiving a request from the first user to resend the first audio data. The method may also include retrieving the first record to identify the first watermark associated with the first user. The method may also include resending the first watermarked data to the first user device.

In a third particular embodiment, a method of processing data may include encoding a watermark into a data file including audio data to form watermarked data. The method may also include storing a record associating the watermark with a purchaser of the watermarked data. The method may also include receiving a request to identify the purchaser based at least in part on the watermarked data. The method may further include charging a fee for identifying the purchaser.

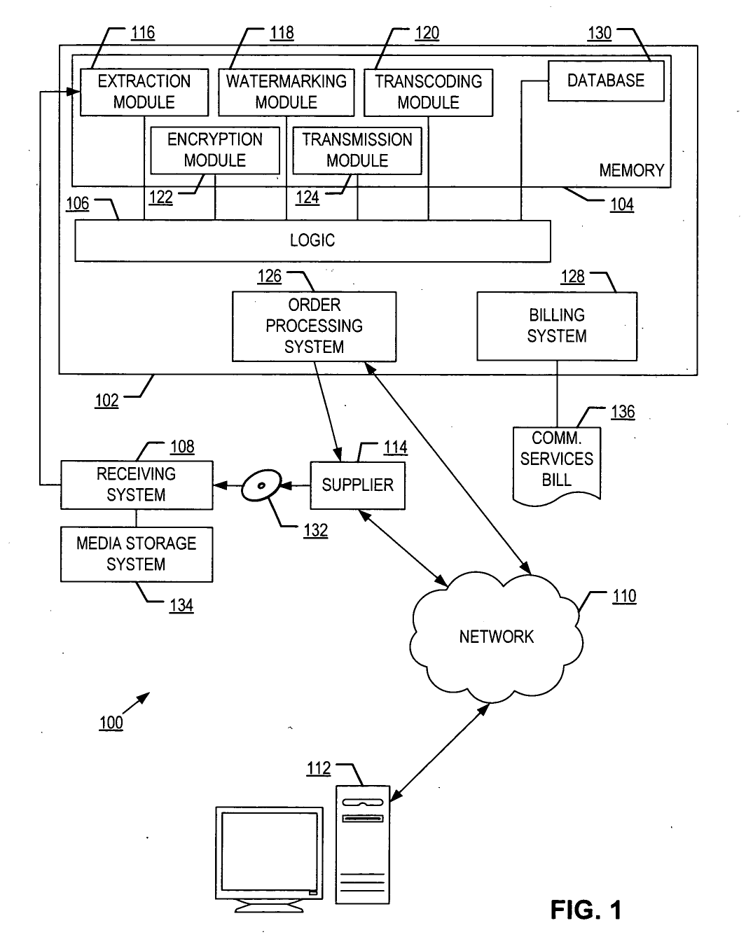

FIG. 1 depicts a block diagram of a particular embodiment of a system 100 for processing data. The data may include audio data, video data, or any combination thereof. The system 100 includes a content provisioning system 102. The content provisioning system 102 includes a memory 104 and logic 106. The system 100 also includes a receiving system 108. The system 100 also includes a network 110 in communication with the content provisioning system 102. Additionally, one or more remote user devices 112 may be in communication with content provisioning system 102 via the network 110. The system 100 may also include one or more suppliers 114.

In a particular embodiment, the content provisioning system 102 may include an extraction module 116, a watermarking module 118, a transcoding module 120, and encryption module 122, and a transmission module 124 in memory 104. In an illustrative embodiment, the content provisioning system 102 may also include an order processing system 126 and a billing system 128. In a particular embodiment, the extraction module 116, watermarking module 118, transcoding module 120, encryption module 122 and transmission module 124 may be executable by the logic 106 to implement a method of processing data. The memory 104 may also include a database 130.

In operation, a user at remote user device 112 may request content data from the content provisioning system 102 or directly from the supplier 114 via the network 110. For example, the content data may include audio data, video data, or any combination thereof. In a particular embodiment, the content data may include any content available to be ordered or delivered to the content provisioning system 102. In an illustrative embodiment, there does not need to be an agreement between a content provisioning system operator and a content provider for content from the content provider to be available via the content provisioning system 102. For example, in an illustrative embodiment, the user may purchase the content directly from the content provider or the content supplier and have the content (perhaps embodied in a particular medium) delivered to the content provisioning system 102. In another illustrative embodiment, the content provisioning system 102 may purchase the content as an agent of the user. Thus, the user may own the particular copy of the content. Therefore, the scope of content that may be delivered using the content provisioning system 102 includes effectively any content available to the user or the content provisioning system 102 through any content supplier.

In a particular illustrative embodiment, the user may request access to the content data via the network 110. In a particular embodiment, when the content data is not available at the content provisioning system 102, the user may place an order for the content data. Order processing system 126 may receive the order and order a copy of the content from supplier 114. The content data may be embodied on a medium, such as a compact disk (CD), a digital video disk (DVD), or another data storage medium 132. The supplier 114 may respond to the order by supplying the medium 132 embodying the requested content data.

In a particular embodiment, the receiving system 108 may receive the medium 132 from the supplier 114. The receiving system 108, the order processing system 126, another portion of the content provisioning system 102, or any combination thereof may catalog the receipt of the medium 132. The receiving system may also communicate with a billing system 128 to bill the user for the order.

In a particular embodiment, the extraction module 116 may create a data file by extracting the content data from the medium 132. The medium 132 may be stored in a media storage system 134. For example, if the medium 132 includes a physical medium, such as a CD or DVD, the media storage system 134 may include a warehousing feature to store and file the media. In a particular embodiment, the medium 132 may be a signal rather than a physical medium. If the medium 132 is a signal, extraction may be omitted. The system 134 may include a database for filing and storing the data embodied in the signal.

The watermarking module 118 may apply a watermark to the data file created by the extraction module 116. In a particular illustrative embodiment, the watermarking module 118 may apply a watermark that may be uniquely identified with the user or purchaser of the particular data file. For example, the watermark may be applied to the data file, and a record of the watermark may be stored. The record may uniquely associate the watermark with the user or purchaser of the particular data file. In another embodiment, a watermark uniquely identifying the user may be applied to the data file. For example, a watermark including encoded information that identifies the user may be applied. In a particular illustrative embodiment, the watermark applied by the watermarking module may include random, pseudo-random or patterned noise added to the data file prior to or after transcoding.

In a particular illustrative embodiment, watermarking may be carried out by adding a noise signal to the data file, and transcoding the data file with the added noise signal. In a particular illustrative embodiment, a noise signal having a low frequency and low amplitude may be added to the data file. For example, the signal may add or subtract a value of one from the least significant digit of modified portions. The modified portions may be selected randomly, semi-randomly, or in a patterned fashion with a low probability that each portion will be selected. For example, a probability of about 1 in 10,000 may be used to select portions to be altered. In a two channel signal (i.e., stereoscopic sound) this equates to about a 1 in 20,000 probability that each portion will be modified. Thus, the resulting data file may include few changes and many, if not all, of those changes will have an amplitude and frequency below the human auditory range. In a particular illustrative embodiment, the data file including the noise signal may be transcoded to a desired data format.

In a particular embodiment, the noise signal embedded in the data file may cause the transcoded data file to have significant differences as compared to the transcoded data file without the noise signal. For example, in a particular test a 1 in 10,000 probability was used to add a noise signal to a dual channel audio data file. The data file with the noise signal was transcoded to a 128 kb MP3 data format. About two-thirds of the frames of the resulting watermarked MP3 data file differed from a control data file formed by transcoding the original data file without the noise signal.

In various embodiments, a watermark may include the noise signal added to the data file, the data file with the noise signal, the transcoded data file with the noise signal, the differences between the data file with the noise signal and the data file without the noise signal, the differences between the transcoded data file with the noise signal and the transcoded data file without the noise signal, other detectible features of the noise or the data file with the noise, or any combination thereof. For example, the watermark may include a record of which frames are different when the data file is transcoded without the noise signal and when the data file is transcoded with the noise signal.

In a particular embodiment, the transcoding module 120 may convert the data file into a desired format. The transcoding module 120 may convert the data file before or after the watermark has been added to the data file. In a particular illustrative embodiment, the watermark may be added to the data file, then the file may be transcoded to the desired format. In a particular illustrative embodiment, the user may select or specify the desired format. The desired format may be a compressed or uncompressed data format. For example, the desired format may include a common format, a lossless format, a lossy format, or another type of data format. Examples of common formats include a waveform audio format (WAV), an audio interchange file format (AIFF), and an Au audio file format. Examples of lossless formats include a free lossless audio codec (FLAC) format, a Monkey's Audio (APE) format, a WavPack (WV) format, a Shorten (SHN) format, a True audio (TTA) format, an Apple lossless encoder (ALE) format, a RealAudio Lossless format, a Meridian Lossless Packing (MLP) format, and a Windows Media Audio (WMA) format. Examples of lossy formats include a motion picture expert's group (MPEG) audio layer three (MP3) data format, an MPEG audio layer two (MP2) format, a Musepack (MPC) format, a Vorbis or Ogg Vorbis (OGG) format, an Advanced Audio coding (AAC) format, an Adaptive transform Acoustic coding (ATRAC) format, and a Dolby Digital format.

In a particular illustrative embodiment, the encryption module 122 may encrypt the watermarked data file. In a particular embodiment, the transmission module 124 may send the encrypted or unencrypted watermarked data file to the user device 112.

In a particular embodiment, the billing system 128 may charge the user a fee for the data file such as via a communication services bill 136. For example, access to media content via the content provisioning system 102 may be offered as part of a bundled service plan available to subscribers of a communication services provider. The bundled services may also be offered to entice non-subscribers to subscribe. In a particular embodiment, the access to media content may be provided for a fixed charge, regardless of the quantity of content accessed by a subscriber. In a particular illustrative embodiment, the subscriber may own or be required to purchase the content before the content is made available to the subscriber.

The data file, the watermarked data file, the transcoded data file, and/or the encrypted data file may be stored in the database 130. In a particular embodiment, the data file may be stored in the database, and a record of the watermark may also be stored in the database. In a particular embodiment, when ownership of a data file is to be verified, the data file may be checked for a watermark. The watermark may be compared to the database to identify the owner of the data file based on the watermark.

In certain circumstances, a user may desire to access the content data again, for example, to receive the data file in a different format, to replace a lost data file, or to store a copy of the data file in a different location. In response to a user request to access the content data again, the content provisioning system 102 may access the data file in the database 130, add a watermark (either the same watermark or a new watermark) to the data file, transcode the data file, encrypt the data file, and resend the data file to the user. In a particular illustrative embodiment, in response to the user's request to access the content data again, the content provisioning system may send a second data file to the user that is distinguishable from the first. For example, the content provisioning system 102 may include a second watermark in the data file that is distinguishable from the first watermark. The second watermark may be uniquely identified with the user or the particular data file. For example, the watermark may be applied to the data file, and a record of the watermark may be stored. The record may uniquely associate the watermark with the user or the particular data file. In an illustrative embodiment, a watermark uniquely identifying the user may be applied to the data file. For example, a watermark including encoded information that identifies the user may be applied.

In a particular embodiment, the user, after receiving the watermarked data file, may access the data file via a computer system, portable media player or other device. If the data file is encrypted, the user may decrypt the data file. In a particular embodiment, the watermark may survive encryption and decryption. The user may store one or more copies of the watermarked data file. If an additional copy of the content is desired, the user may create a copy of the watermarked data file or may request that the content provisioning system 102 provide an additional copy. In a particular embodiment, the watermark may survive copying of the watermarked data file.

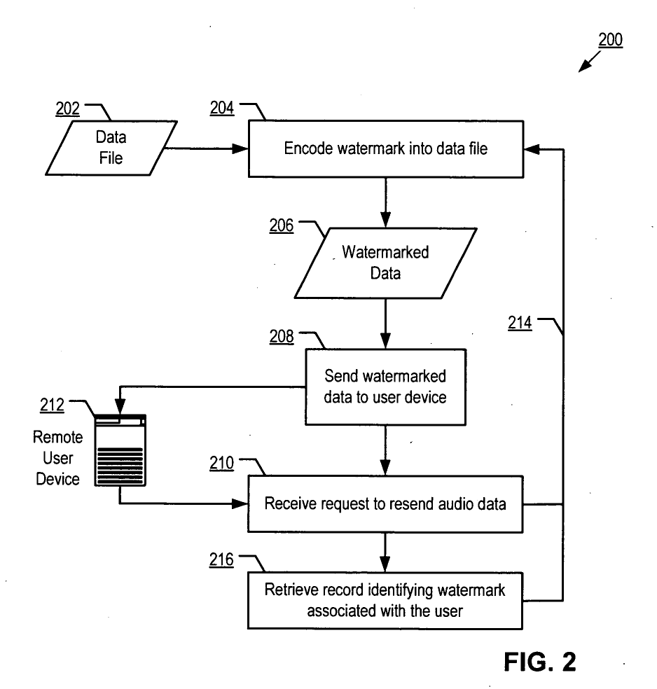

FIG. 2 depicts a flow chart of a first particular embodiment of a method 200 of processing data. The method 200 includes, at 204, encoding a first watermark into a data file 202 to form first watermarked data 206. The data file 202 may include content such as audio data, video data, or any combination thereof.

The method 200 also includes, at 208, sending the watermarked data 206 to a remotely located user device 212 associated with the user. The method 200 also includes, at 210, receiving a request to resend content of the data file 202. In response to receiving the request to resend the content, the method 200 may include (via loop 214) encoding a second watermark into the data file 202 to form second watermarked data. The method 200 may also include sending the second watermarked data to the remote user device 212.

In another particular illustrative embodiment, in response to receiving the request to resend the audio data, the method 200 may include, at 216, retrieving a record identifying the first watermark associated with the user. The watermarked data 206 associated with the user may be retrieved, or the watermark may be encoded into the data file 202 to form the watermarked data 206 again. The watermarked data 206 may be resent to the remote user device 212. In another illustrative embodiment, a new watermark may be applied to the data file 202 to form second watermarked data.

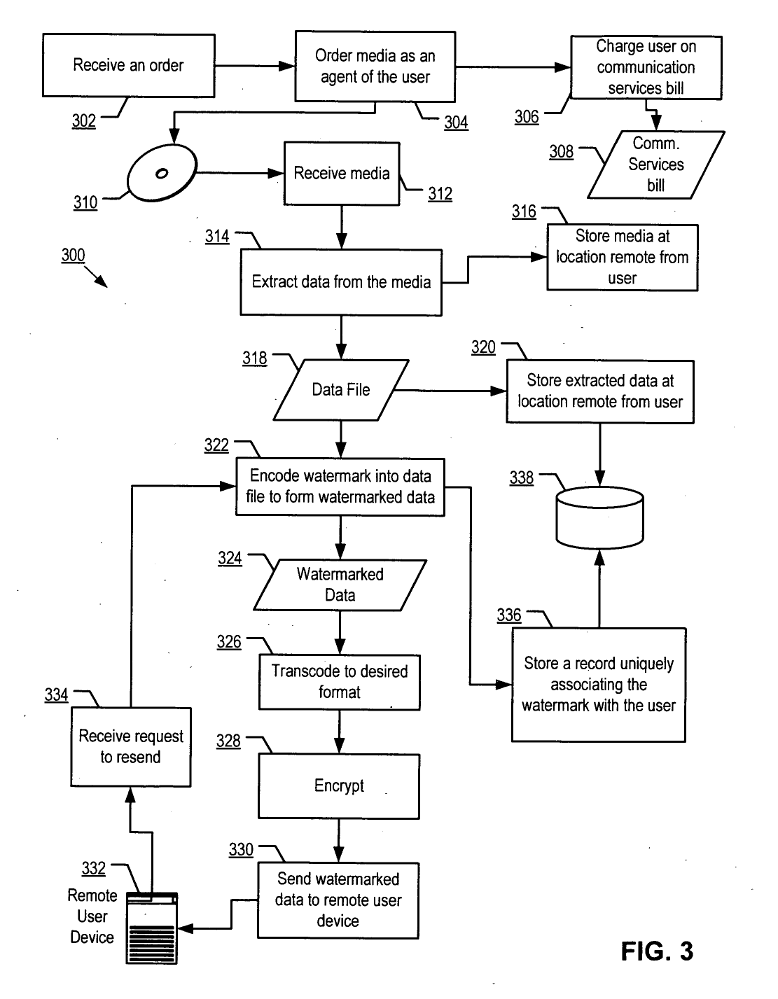

FIG. 3 depicts a flow chart of a second particular embodiment of a method of processing data. The method 300 includes receiving an order for a copy of content, such as audio data, video data, or any combination thereof. The method 300 may also include ordering media embodying the ordered content data as an agent of the user at 304.

In a particular illustrative embodiment, at 306, the user may be charged for the order, a data carrier 310 embodying the content, access to the content, other services associated with access to the content or any combination thereof on a communication services bill 308. The data carrier 310 may be received, at 312. The data carrier 310 may include any physical or non-physical medium embodying the content data. The method 300 may also include, at 314, extracting data from the data carrier 310 to form a data file 318. In a particular embodiment, the method 300 may include, at 316, storing the data carrier 310 at a location remote from the user. In a particular embodiment, the method may also include, at 320, storing the extracted data at a location remote from the user.

In a particular embodiment, the method 300 may include, at 322, encoding a watermark into the data file 318 to form watermarked data 324. In a particular embodiment, the method may include, at 326, transcoding or converting the watermarked data 324 to a desired format. The watermarked data 324 may be encrypted, at 328, before being sent, at 330, to a remote user device 332. In a particular illustrative embodiment, the method 300 may include storing a record that uniquely associates the watermark with the user, at 336. For example, the record uniquely associating the watermark with the user may be stored in a database 338.

In a particular embodiment, the method 300 may also include, at 334, receiving a request from the user to resend the content data. In response to receiving the request to resend the content data, the method 300 may include encoding a second watermark into the data file to form second watermark data, at 322. In a particular embodiment, the second watermark may be distinguishable from the first watermark, so that the second watermarked data may be distinguished from the first watermarked data.

In a particular embodiment, the method 300 may include, at 336, storing a record that uniquely associates the second watermark with the user. In a particular illustrative embodiment, the second watermark may be substantially the same as the first watermark. For example, the record uniquely associating the first watermark with the user may be accessed and the first watermark may again be applied to the data file to form the second watermarked data.

In a particular embodiment, the second watermarked data may be transcoded, at 326, to a desired format. The transcoded data may be sent, at 330, to the remote user device 332.

In a particular embodiment, the first and/or second watermarked data may be stored in a database, such as database 338. In response to receiving a request to resend the data file, the method 300 may include accessing the watermarked data 324 from the database 338, and resending the watermarked data to remote user device 332.

In a particular illustrative embodiment, a request to resend the content data may include a request to resend the content data in a different data format. For example, the user may have initially requested, and been sent a data file having an MP3 format, and the request to resend the data file may include a request to send a data file having an OGG format. In response to receiving the request to resend the data in a different data format, the method may include encoding a watermark into the data file to form second watermarked data, transcoding the second watermarked data into the new desired format and sending the watermarked data to the remote user device 332.

In a particular embodiment, the user may request access to additional content data. The method 300 may include storing a record that uniquely associates the user with watermarks applied to a plurality of content data. For example, the record uniquely associating the watermark with the user may be a part of a catalog identifying content data associated with the user and watermarks applied to the content data before the data was sent to the user. In such an embodiment, the user may be able to request that any content data previously provided to the user be resent. The method 300 may include resending watermarked data to the user as previously described. Additionally, the method 300 may include receiving a request from the user that any content data previously sent to the user be transcoded to a new format. In a particular embodiment, the user may not be billed for accessing content a second or subsequent time. Alternately, the user may be billed a first amount for an initial access to the content, and a second amount for a second access to the content. The first amount may be different than the second amount, for example, the first amount may be greater than the second amount. The user may be charged other amounts for subsequent access to the content data, or may be billed the first or second amount again. In a particular illustrative embodiment, the first amount may be a higher amount to pay for data carrier and data processing (e.g., extraction, watermarking, transcoding, encrypting, storing, and sending the content), the second amount may be a lesser amount to pay for the data processing, or there may be no charge for the second and subsequent access to the content.

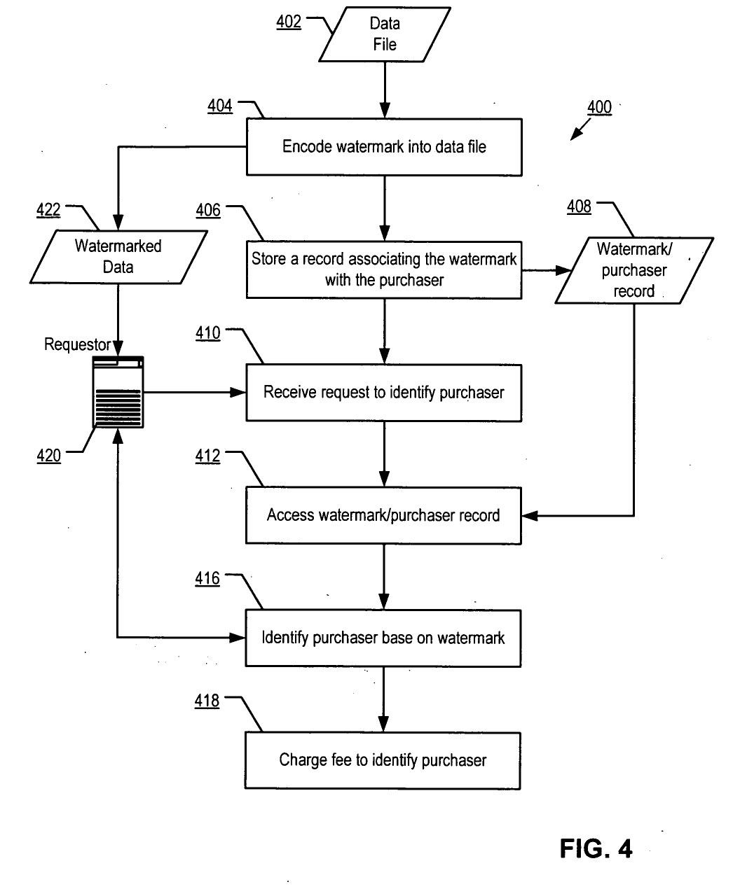

FIG. 4 depicts a flow chart of a third particular embodiment of a method of processing data. The method 400 includes, at 404, encoding a watermark into a data file 402. The method 400 also includes, at 406, storing a record 408 associating the watermark with a content purchaser.

In a particular embodiment, the method 400 may include, at 410, receiving a request to identify the purchaser. In response to receiving the request to identify the purchaser, the method 400 may include, at 412, accessing the watermark/purchaser record 408. In a particular embodiment, the method 400 may include, at 416, identifying the purchaser based on the watermark/purchaser record 408 and the watermark data 422. In a particular embodiment, the method 400 may include, at 418, charging a requestor 420 a fee for identifying the purchaser.

In a particular embodiment, a requestor 420 may desire to determine whether a possessor of a particular data file is a rightful possessor, e.g., the purchaser of the data file. The requestor 420 may request information about the data file such as, whether the data file includes a watermark, whether the watermark is associated with a particular person or transaction, other information related to the data file, watermark, purchaser, user, transaction, or any combination thereof. The requestor 420 may submit the data file or information about the data file. A database of records pertaining to watermarks may be consulted to determine the requested information. The requestor 420 may be provided the requested information for a fee. In another particular embodiment, the purchaser of the data file may act as the requestor 420 to gather information indicative of his or her ownership or rightful possession of the data file 402. In an illustrative embodiment, the purchaser may not be charged a fee for access to the requested information.

In a particular embodiment, the steps of the methods described herein may be executed in the order shown by the figures. In alternative embodiments, the steps may be executed in alternative sequences. Although certain of the embodiments discussed have largely dealt with audio data files, it is understood that the methods and systems disclosed may also be used to process video data files, audio/video data files, multimedia data files, other kinds of data files, or any combination thereof.

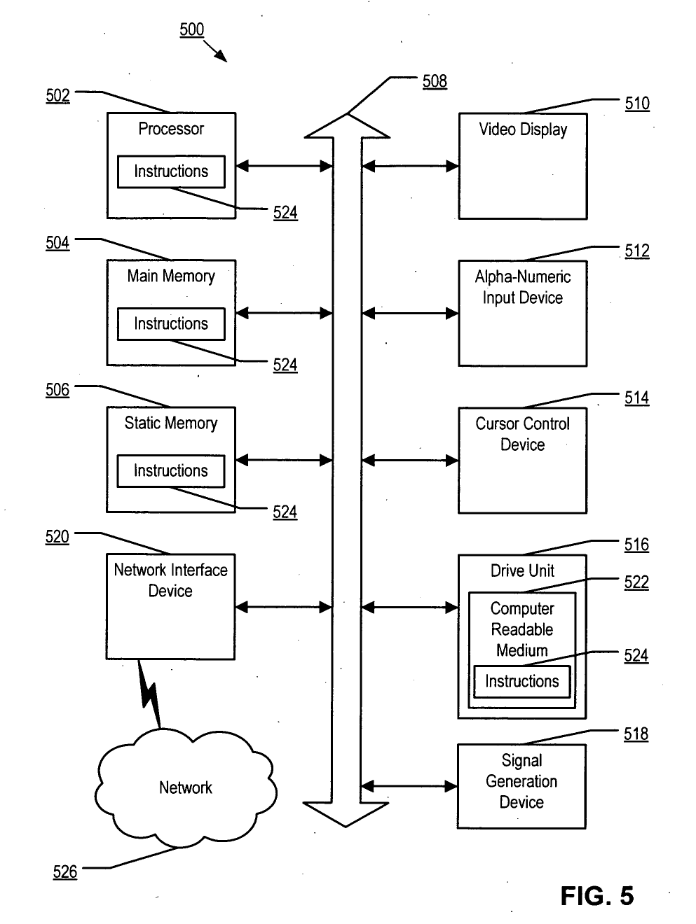

Referring to FIG. 5, an illustrative embodiment of a general computer system is shown and is designated 500. The computer system 500 can include a set of instructions that can be executed to cause the computer system 500 to perform any one or more of the methods or computer based functions disclosed herein. The computer system 500 may operate as a standalone device or may be connected, e.g., using a network, to other computer systems or peripheral devices, such as a remote user device, a content provisioning system, or a requester device, as illustrated in FIGS. 1, 2, 3, and 4.

In a networked deployment, the computer system may operate in the capacity of a server or as a client user computer in a server-client user network environment, or as a peer computer system in a peer-to-peer (or distributed) network environment. The computer system 500 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, a portable media player, or any other machine capable of executing a set of instructions (sequential or otherwise) that specify actions to be taken by that machine. In a particular embodiment, the computer system 500 can be implemented using electronic devices that provide audio, voice, video or data communication. Further, while a single computer system 500 is illustrated, the term “system” shall also be taken to include any collection of systems or sub-systems that individually or jointly execute a set, or multiple sets, of instructions to perform one or more computer functions.

As illustrated in FIG. 5, the computer system 500 may include a processor 502, e.g., a central processing unit (CPU), a graphics processing unit (GPU), or both. Moreover, the computer system 500 can include a main memory 504 and a static memory 506, that can communicate with each other via a bus 508. As shown, the computer system 500 may further include a video display unit 510, such as a liquid crystal display (LCD), an organic light emitting diode (OLED), a flat panel display, a solid state display, or a cathode ray tube (CRT). Additionally, the computer system 500 may include an input device 512, such as a keyboard, and a cursor control device 514, such as a mouse. The computer system 500 can also include a disk drive unit 516, a signal generation device 518, such as a speaker or remote control, and a network interface device 520.

In a particular embodiment, as depicted in FIG. 5, the disk drive unit 516 may include a computer-readable medium 522 in which one or more sets of instructions 524, e.g. software, can be embedded. Further, the instructions 524 may embody one or more of the methods or logic as described herein. In a particular embodiment, the instructions 524 may reside completely, or at least partially, within the main memory 504, the static memory 506, and/or within the processor 502 during execution by the computer system 500. The main memory 504 and the processor 502 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limiting embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 524 or receives and executes instructions 524 responsive to a propagated signal, so that a device connected to a network 526 can communicate audio, voice, video or data over the network 526. Further, the instructions 524 may be transmitted or received over the network 526 via the network interface device 520.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory-or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of processing data, the method comprising: encoding a first watermark into a data file to form first watermarked data, the data file including audio data;
sending the first watermarked data to a remotely located user device associated with a user;
receiving a request from the user to resend the audio data;
encoding a second watermark into the data file to form second watermarked data; and
sending the second watermarked data to the user device.

2. The method of claim 1, further comprising:
receiving media embodying the audio data; and
extracting the audio data from the media to form the data file.

3. The method of claim 1, wherein the user owns the copy of the audio data in the data file.

4. The method of claim 1, further comprising storing a record associating the first watermark with the user.

5. The method of claim 1, further comprising charging the user a first fee for the first watermarked data.

6. The method of claim 1, further comprising charging the user a second fee for the second watermarked data.

7. The method of claim 1, further comprising not charging the user a fee for the second watermarked data.

8. The method of claim 1, wherein the second watermarked data is distinguishable from the first watermarked data.

9. The method of claim 1, wherein the data file further includes video data.

10. A method of processing data, the method comprising:
encoding a first watermark into a first data file to form first watermarked data, the first data file including first audio data;
storing a first record associating the first watermark with a first user;
sending the first watermarked data to a remotely located first user device associated with the first user;
receiving a request from the first user to resend the first audio data;
retrieving the first record to identify the first watermark associated with the first user; and
resending the first watermarked data to the first user device.

11. The method of claim 10, wherein encoding the first watermark into the first data file includes transcoding the first audio data and computer detectable noise into a desired data format.

12. The method of claim 10, further comprising receiving an order for a copy of the first audio data before encoding the first watermark into the first data file.

13. The method of claim 10, further comprising charging the user a fee via a communication services bill after sending the first watermarked data to the first user device.

14. The method of claim 10, further comprising:
encoding a second watermark into a second data file to form second watermarked data, the second data file including second audio data;
storing a second record associating the second watermark with the first user; and
sending the second watermarked data to the remotely located first user device.

15. The method of claim 10, further comprising:
encoding a second watermark into the first data file to form second watermarked data;
storing a second record associating the second watermark with a second user; and
sending the second watermarked data to a remotely located second user device associated with the second user.

16. The method of claim 15, wherein the first watermarked data has a first data format, and the second watermarked data has a second data format.

17. A method of processing data, the method comprising:
encoding a watermark into a data file including audio data to form watermarked data;
storing a record associating the watermark with a purchaser of the watermarked data;
receiving a request to identify the purchaser based at least in part on the watermarked data; and
charging a fee for identifying the purchaser.

18. The method of claim 17, wherein the data file further comprises video data.

19. A system, comprising:
a watermarking module to embed a computer detectible watermark within audio data to form watermarked data;
a memory to store a record associating the computer detectible watermark with a user;
a transmission module to send the watermarked data to a user device; and
logic in communication with the memory;
wherein, in response to receiving a request to resend the audio data:
the logic identifies the watermark associated with the user; and
the transmission module resends the watermarked data to the user device.

20. The system of claim 19, further comprising an extraction module to extract the audio data from a data carrier.

21. The system of claim 19, further comprising an order processing module to receive an order for a copy of the audio data and to order the audio data as an agent of the user.

22. The system of claim 19, further comprising a billing module to bill the user on a communication services bill.

23. The system of claim 19, further comprising a media storage module to store a data carrier embodying the audio data at a location remote from the user device.

24. The system of claim 19, further comprising a transcoding module to transcode the watermarked data to a desired format.

25. The system of claim 24, wherein the desired format is specified by the user.

26. The system of claim 19, further comprising a data storage module to store the audio data at a location remote from the user device.

27. The system of claim 19, further comprising an encryption module to encrypt the watermarked data.

28. A system, comprising:
a watermarking module to embed a first watermark within audio data to form first watermarked data; and
a transmission module to send the first watermarked data to a user device;
wherein, in response to receiving a request to resend the audio data:
the watermarking module embeds a second watermark within the audio data to form second watermarked data; and
the transmission module sends the second watermarked data to the user device.

29. The system of claim 28, further comprising a memory to store a record associating the first watermark with a user of the user device.

30. The system of claim 28, further comprising an order processing module to receive an order for a copy of the audio data and to order a data carrier embodying the audio data as an agent of the user.
